(19) United States
(12) Patent Application Publication
(10) Pub. No.: US 2012/0095728 A1
(43) Pub. Date: Apr. 19, 2012

(54) DATA PROCESSING APPARATUS, PERFORMANCE EVALUATION/ANALYSIS APPARATUS, AND PERFORMANCE EVALUATION/ANALYSIS SYSTEM AND METHOD

(75) Inventor: Atsushi UBUKATA, Kyoto (JP)

(73) Assignee: PANASONIC CORPORATION, Osaka (JP)

(21) Appl. No.: 13/333,281

(22) Filed: Dec. 21, 2011

Related U.S. Application Data
(63) Continuation of application No. PCT/JP2010/004167, filed on Jun. 23, 2010.

(30) Foreign Application Priority Data
Jun. 30, 2009 (JP) 2009-156385

(51) Int. Cl. G06F 11/30

(52) U.S. Cl. 702/186

(57) ABSTRACT

A data processing apparatus is provided which allows easy identification of a correspondence relationship between a trace packet and a performance packet. The data processing apparatus includes: a measurement trigger generation unit that generates a measurement trigger; a performance monitor unit that measures a performance measurement event collected from a central processing unit (CPU) and outputs a measurement value; and a CPU trace unit that generates a trace packet sequence of trace information including an operation record of the CPU. Upon receipt of the measurement trigger, the performance monitor unit starts or ends measurement of performance metrics or outputs the measurement value, while, upon receipt of the measurement trigger, the CPU trace unit generates a trigger packet indicating generation of the measurement trigger and inserts the trigger packet, at a position corresponding to timing with which the measurement trigger is generated, into the trace packet sequence.

### CROSS REFERENCE TO RELATED APPLICATIONS

This is a continuation application of PCT Patent Application No. PCT/JP2010/004167 filed on Jun. 23, 2010, designating the United States of America, which is based on and claims priority of Japanese Patent Application No. 2009-156385 filed on Jun. 30, 2009. The entire disclosures of the above-identified applications, including the specifications, drawings and claims are incorporated herein by reference in their entirety.

### BACKGROUND OF THE INVENTION

(1) Field of the Invention

The present invention relates to performance evaluation of processor cores and particularly to a data processing apparatus, a performance evaluation/analysis apparatus, and a data processing apparatus which output performance measurement values in association with trace information, as well as a performance evaluation/analysis system, a performance evaluation/analysis method, and a semiconductor device which collect and analyze performance metrics.

(2) Description of the Related Art

Aiming at performance evaluation and improvement of software that is executed by a processor core (central processing unit abbreviated as CPU), software profiling using what is called a performance monitor is performed. In general, the performance monitor is made up of a performance counter for counting occurrences of events related to performance evaluation, and a circuit for reading out the counts. Performance indexes of measurement are various such as the number of machine cycles, the number of instruction executions, the number of cache misses, the number of TLB misses, the number of stall cycles, and the number of occurrences of conflicts, within a measurement period, and determined according to characteristics of hardware, centering on a part thereof which is likely to be a bottleneck. As a range of the measurement, a predetermined period of software or periods at regular intervals with use of a timer are commonly applied.

Conventionally, software controls a performance counter, thereby reading out values of the performance counter and storing the values into a log region of a main memory to obtain statistical data of performance metrics. A start-up of a performance monitor and a read-out from the performance counter are triggered by an occurrence of task switching in an operating system (OS), an interrupt in an execution of a specific instruction (function call/return), or the like (see Patent Literature 1: Japanese Unexamined Patent Application Publication No. 2009-75812, for example). In another example, “the number of counts of execution cycles” included in performance information is output to a trace upon an execution of a specific instruction (function call/return), an occurrence of an interrupt, or the like (see Patent Literature 2: Japanese Patent No. 4138021, for example).

### SUMMARY OF THE INVENTION

However, the performance counter read-out method using software consumes CPU throughput and memory resources, which somewhat affects an execution time of a software module to be measured. For example, there is a case where the impact on a measurement target by the measurement is not negligible, such as where the state of a cache changes due to processing of read-out from the performance counter, causing a large number of cache misses such that an execution time measured is longer than that in a normal operation in which the performance monitor is not operating. Especially, in the case of real-time processing, it may be required that measurement with high accuracy be left out. Furthermore, even when a CPU trace has been obtained to analyze a detailed operation of a processor, a human needs to find correspondence between statistical performance data and the CPU trace. Thus, it used to be difficult to find where to improve in a correlation with the detailed operation of CPU.

Meanwhile, using the method in which data of the performance counter is output to a CPU trace, there is no longer the problem of synchronization with the CPU trace, but, in the case of attempting to simultaneously obtain a large number of pieces of performance metrics data, a large buffer is required to keep packet output of the CPU trace waiting during the output of the performance counter, which causes a problem of an increase in cost of hardware.

In order to solve the above problems, an object of the present invention is to provide a data processing apparatus, a performance evaluation/analysis apparatus, a performance evaluation/analysis system, a performance evaluation/analysis method, and a semiconductor device which allow a human to easily distinguish which trace packet corresponds to which performance packet among a trace packet sequence and a performance packet sequence that are measured and output separately.

In order to solve the first problem, that is, the problem of synchronization between the CPU trace and the performance counter, an aspect of the present invention uses a measurement trigger common to the CPU trace and the performance monitor. In the CPU trace, an event packet is inserted with timing of generation of a measurement trigger, while, in the performance monitor, a start of measurement and output of measurement data are controlled with the same measurement trigger. With this, the CPU trace data and the performance monitor can be associated with one trigger.

In order to solve the second problem, that is, the problem of an increase in required buffer space for outputting a large number of data from the performance counter, an arbiter is provided to arbitrate output between the CPU trace and the performance counter so as to give high priority to output of the CPU trace. With this, an increase in bandwidth required for trace due to output of the performance counter can be reduced.

The data processing apparatus for solving the above problems includes: a measurement trigger generation unit configured to generate a measurement trigger; a performance monitor circuit that measures a performance measurement event collected from a central processing unit (CPU) and outputs a measurement value; and a CPU trace circuit that generates, based on a signal indicating an operating state of the CPU, a trace packet sequence of trace information including an operation record of the CPU, wherein upon receipt of the measurement trigger, the performance monitor circuit starts or ends measurement of performance metrics or outputs the measurement value, the signal indicating an operating state of the CPU includes at least one of an address of an instruction executed by the CPU and identification information indicating a specific trace instruction executed by the CPU, the performance metrics include at least one of the number of machine cycles, the number of instruction executions, the number of cache misses, the number of translation lookaside buffer (TLB) misses, the number of stall cycles, and the number of occurrences of conflicts, each of the numbers being counted within a period determined according to the measurement trigger, and upon receipt of the measurement trigger, the CPU trace circuit generates a trigger packet and inserts the trigger packet into the trace packet sequence, the trigger packet indicating generation of the measurement trigger and being inserted at a position corresponding to timing with which the measurement trigger is generated.

With this structure, the use of the measurement trigger common to the CPU trace and the performance monitor allows a human to easily associate statistical performance information with information such as a trace of program execution flow or a cache miss address by referring to a packet of the measurement trigger inserted into the information.

Here, it may be possible that the performance monitor circuit includes at least one counter which measures the performance metrics, the measurement trigger is a measurement start trigger, and upon receipt of the measurement start trigger, the performance monitor circuit starts a counting operation of the at least one counter.

With this structure, the measurement of the performance metrics can be started with the measurement start trigger.

Here, it may be possible that the performance monitor circuit includes: at least one counter which measures the performance metrics; a read buffer into which the measurement value is copied from the at least one counter; and a packetizing unit configured to packetize the measurement value copied into the read buffer and output the packetized measurement value as a performance packet, the measurement trigger is a measurement transfer trigger, and upon receipt of the measurement transfer trigger, the performance monitor circuit copies the measurement value from the at least one counter into the read buffer and starts a sequence operation of the packetizing unit, the sequence operation including the packetizing and the outputting of the performance packet.

With this structure, the performance metrics can be output with the measurement transfer trigger. What is more, the read buffer does not need a large capacity because the measurement value in the read buffer can be erased after the packetizing unit packetizes the measurement value and outputs the packetized measurement value.

Here, it may be possible that the performance monitor circuit includes: at least one counter which measures the performance metrics; a read buffer into which the measurement value is copied from the at least one counter; and a packetizing unit configured to packetize the measurement value copied into the read buffer and output the packetized measurement value as a performance packet, the measurement trigger is a measurement end trigger, and upon receipt of the measurement end trigger, the performance monitor circuit copies the measurement value from the at least one counter into the read buffer, starts a sequence operation of the packetizing unit, and stops a counting operation, the sequence operation including the packetizing and the outputting of the performance packet.

With this structure, the measurement of the performance metrics can be ended with the measurement end trigger.

Here, the data processing apparatus may include an arbitration unit configured to arbitrate, according to a predetermined user setting, a conflict between a trace packet received from the CPU trace circuit and a performance packet received from the performance monitor circuit, and output the trace packet and the performance packet.

With this structure, when the trace packet conflicts with the performance packet, a packet which a user considers is important can be preferentially output.

Here, the data processing apparatus may include an arbitration unit configured to arbitrate a conflict between a trace packet received from the CPU trace circuit and a performance packet received from the performance monitor circuit so that high priority is given to the trace packet, and output the trace packet and the performance packet.

With this structure, when the trace packet conflicts with the performance packet, the trace packet can be preferentially output.

Here, it may be possible that the performance monitor circuit performs one of the following (i) and (ii) according to a user setting, when a new measurement trigger is generated while the performance packet yet to be output remains because of the high priority given to the trace packet by the arbitration unit: (i) discarding the remaining performance packet and generating the performance packet which corresponds to the new measurement trigger; and (ii) stopping generating the performance packet which corresponds to the new measurement trigger, without discarding the remaining performance packet.

With this structure, out of the remaining performance packet yet to be output and the performance packet corresponding to the new measurement trigger, which packet is given high priority can be selected according to a user setting.

Here, it may be possible that the performance monitor circuit includes: at least one counter which measures the performance metrics; a read buffer into which the measurement value is copied from the at least one counter; and a packetizing unit configured to packetize the measurement value copied into the read buffer and output the packetized measurement value as a performance packet, and the performance packet includes identification information on the measurement trigger, a class of a count, and the count.

With this structure, since the performance packet includes the identification information on the measurement trigger, the class of the count, and the count, the performance packet may be variable in length, and the number of performance packets for each measurement trigger may also be variable, which allows an increase in the flexibility of output sequence of the performance packet.

Here, it may be possible that the performance monitor circuit includes: at least one counter which measures the performance metrics; a read buffer into which the measurement value is copied from the at least one counter; and a packetizing unit configured to packetize the measurement value copied into the read buffer and output the packetized measurement value as a performance packet, and the packetizing unit is configured to generate a predetermined fixed number of performance packets every time the measurement trigger is generated.

With this structure, every time the measurement trigger is generated, the predetermined number of performance packets are generated, with the result that the identification information on the measurement trigger does not need to be added to each performance packet and therefore can be omitted. This is because the performance evaluation/analysis apparatus which receives the performance packet sequence is readily able to achieve the association only by counting, for each trigger packet inserted into the trace packet sequence, the predetermined number of performance packets which correspond to the trigger packet.

Here, in the performance evaluation/analysis apparatus for solving the above problems, the performance monitor circuit includes: at least one counter which measures the performance metrics; a read buffer into which the measurement value is copied from the at least one counter; and a packetizing unit configured to packetize the measurement value copied into the read buffer and output the packetized measurement value as a performance packet, and the packetizing unit is configured to generate a predetermined fixed number of performance packets every time the measurement trigger is generated.

The performance evaluation/analysis system for solving the above problems is a performance evaluation/analysis apparatus which receives a trace packet sequence and a performance packet sequence from a data processing apparatus, wherein a performance packet included in the performance packet sequence includes at least one of the number of machine cycles, the number of instruction executions, the number of cache misses, the number of translation lookaside buffer (TLB) misses, the number of stall cycles, and the number of occurrences of conflicts, each of the numbers being counted within a period determined according to a measurement trigger, a trace packet included in the trace packet sequence includes: at least one of an address of an instruction executed by a central processing unit (CPU) and identification information indicating a specific trace instruction executed by the CPU; and a trigger packet indicating generation of the measurement trigger, and the performance evaluation/analysis apparatus includes: a first storage unit configured to store, as a first log, the trace packet sequence received from the data processing apparatus; a second storage unit configured to store, as a second log, the performance packet sequence received from the data processing apparatus; and an analysis unit configured to (i) identify a position, in the first log, of a trigger packet embedded in the first log, (ii) associate the trace packet and the performance packet according to the position, and (iii) output information indicating a correspondence relationship between the trace packet and the performance packet.

The performance evaluation/analysis system for solving the above problems includes the above data processing apparatus and the above performance evaluation/analysis apparatus.

The performance evaluation/analysis method for solving the above problems is a performance evaluation/analysis method in a performance evaluation/analysis apparatus which receives a trace packet sequence and a performance packet sequence from a data processing apparatus, wherein a performance packet included in the performance packet sequence includes at least one of the number of machine cycles, the number of instruction executions, the number of cache misses, the number of translation lookaside buffer (TLB) misses, the number of stall cycles, and the number of occurrences of conflicts, each of the numbers being counted within a period determined according to a measurement trigger, a trace packet included in the trace packet sequence includes: at least one of an address of an instruction executed by a central processing unit (CPU) and identification information indicating a specific trace instruction executed by the CPU; and a trigger packet indicating generation of the measurement trigger, and the performance evaluation/analysis method includes: storing, as a first log, the trace packet sequence received from the data processing apparatus; storing, as a second log, the performance packet sequence received from the data processing apparatus; identifying a position, in the first log, of a trigger packet embedded in the first log; associating the trace packet and the performance packet according to the position; and outputting information indicating a correspondence relationship between the trace packet and the performance packet.

The semiconductor device for solving the above problems includes: a measurement trigger generation unit configured to generate a measurement trigger; a performance monitor circuit that measures a performance measurement event collected from a central processing unit (CPU) and outputs a measurement value; and a CPU trace circuit that generates, based on a signal indicating an operating state of the CPU, a trace packet sequence of trace information including an operation record of the CPU, wherein upon receipt of the measurement trigger, the performance monitor circuit starts or ends measurement of performance metrics or outputs the measurement value, the signal indicating an operating state of the CPU includes at least one of an address of an instruction executed by the CPU and identification information indicating a specific trace instruction executed by the CPU, the performance metrics include at least one of the number of machine cycles, the number of instruction executions, the number of cache misses, the number of translation lookaside buffer (TLB) misses, the number of stall cycles, and the number of occurrences of conflicts, each of the numbers being counted within a period determined according to the measurement trigger, and upon receipt of the measurement trigger, the CPU trace circuit generates a trigger packet and inserts the trigger packet into the trace packet sequence, the trigger packet indicating generation of the measurement trigger and being inserted at a position corresponding to timing with which the measurement trigger is generated.

The use of the measurement trigger common to the CPU trace and the performance monitor facilitates association of the statistical performance information with information such as a trace of program execution flow or a cache miss address by referring to a packet of the measurement trigger inserted into the information, with the result that detailed information on what happens at a point having a deteriorated performance index can be obtained from the CPU trace. This helps a system developer improve the performance.

Furthermore, by providing the arbiter which arbitrates output between the CPU trace and the performance counter and giving high priority to the output of the CPU trace, the increase in bandwidth required for trace due to the output of the performance counter can be reduced, with the result that the total buffer space required to output the CPU trace can be reduced.

### BRIEF DESCRIPTION OF THE DRAWINGS

These and other objects, advantages and features of the invention will become apparent from the following description thereof taken in conjunction with the accompanying drawings that illustrate a specific embodiment of the present invention. In the Drawings:

FIG. 1A shows a structure of a data processing apparatus according to Embodiment 1 of the present invention;

FIG. 1B shows an example of a structure of a performance counter 410 according to Embodiment 1 of the present invention;

FIG. 1C shows an example of a structure of a trace packet generated by a trace packet generation unit according to Embodiment 1 of the present invention;

FIG. 1D shows an example of a structure of a performance counter packet generated by a packetizing unit according to Embodiment 1 of the present invention;

FIG. 1E shows another example of the structure of the performance counter packet generated by the packetizing unit according to Embodiment 1 of the present invention;

FIG. 2 is a timing chart showing a CPU trace and data output of a performance monitor in the data processing apparatus according to Embodiment 1 of the present invention;

FIG. 3A shows a performance evaluation/analysis system including the data processing apparatus and an external analysis apparatus according to Embodiment 1 of the present invention;

FIG. 3B is a flowchart showing a performance evaluation/analysis method in the analysis apparatus according to Embodiment 1 of the present invention;

FIG. 4A shows a CPU trace log and a performance monitor log collected by the external analysis apparatus;

FIG. 4B is a measurement trigger event correspondence table created by the external analysis apparatus;

FIG. 4C shows a correspondence relationship between performance monitor information and CPU trace information in the external analysis apparatus;

FIG. 5 shows a structure of a data processing apparatus according to Embodiment 2 of the present invention;

FIG. 6 is a timing chart showing a CPU trace and data output of a performance monitor in the data processing apparatus according to Embodiment 2 of the present invention;

FIG. 7 shows a performance evaluation/analysis system including the data processing apparatus and an external analysis apparatus according to Embodiment 2 of the present invention;

FIG. 8A shows a trace log collected by the external analysis apparatus;

FIG. 8B is a measurement trigger event correspondence table created by the external analysis apparatus; and

FIG. 8C shows a correspondence relationship between performance monitor information and CPU trace information in the external analysis apparatus.

### DESCRIPTION OF THE PREFERRED EMBODIMENTS

### Embodiment 1

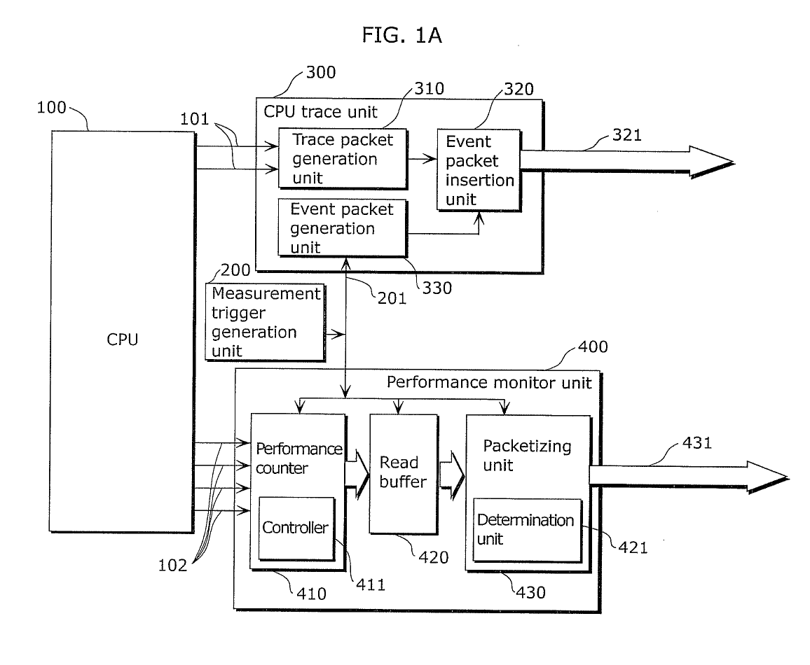

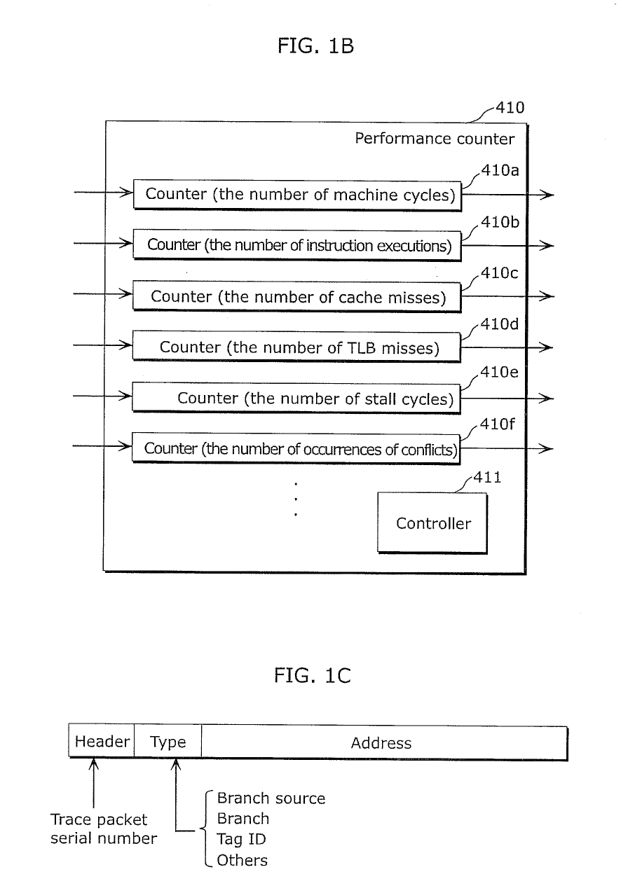

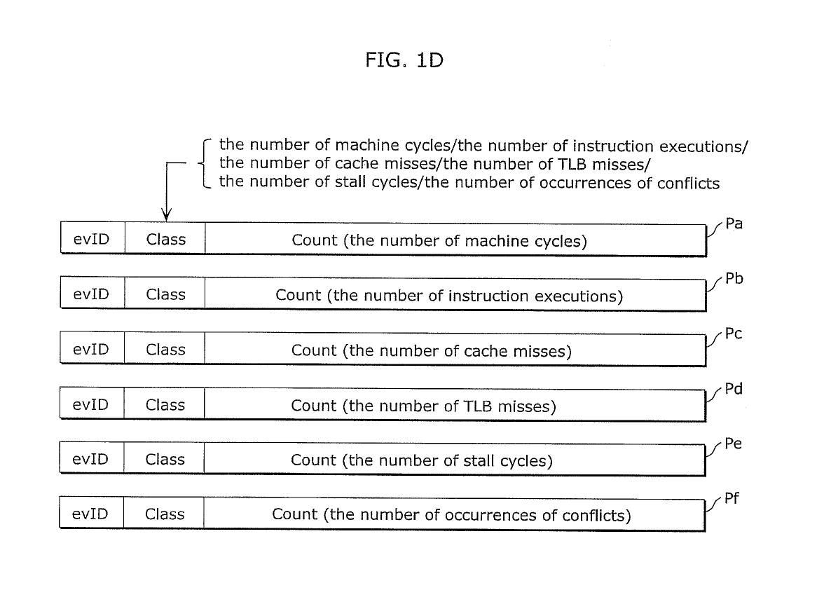

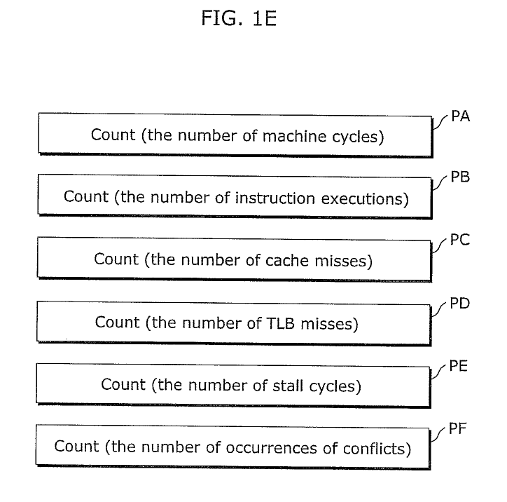

FIG. 1A shows a structure of a data processing apparatus according to Embodiment 1 of the present invention. This data processing apparatus includes a CPU 100 that executes software. From the CPU 100, CPU-related trace information 101 is input to a CPU trace unit 300 and converted by a trace packet generation unit 310 into a CPU trace packet. In addition, from the CPU 100, a performance measurement event 102, such as the number of machine cycles, the number of instruction executions, the number of cache misses, the number of TLB misses, the number of stall cycles, or the number of occurrences of conflicts, collected to evaluate performance, is input to a performance monitor unit 400 and for every occurrence of each event, added to a performance counter. The number of occurrences of conflicts indicates the number of occurrences of performance degradation due to conflicts of requests to use a shared resource, such as a bus, a memory, or a computing unit.

A measurement trigger generation unit 200 generates a measurement trigger 201 for controlling a statistic operation of performance evaluation. A source of the measurement trigger may be an event occurring in a predetermined cycle because of overflow of a timer (not shown) or may be detection, by the CPU 100, of an execution of a function call/return instruction. It may also be that an instruction for debugging only is embedded in a program which the CPU 100 runs, and when the program is run, the measurement trigger generation unit 200 is notified thereof.

Upon assertion of the measurement trigger 201, the CPU trace unit 300 generates an event packet corresponding to the measurement trigger 201 in an event packet generation unit 330 and interrupts the CPU trace with the generated event packet in an event packet insertion unit 320, whereafter a trace terminal output 321 is provided from a trace terminal. The event packet is also referred to herein as a trigger packet.

Meanwhile, the performance monitor unit 400 receives the same measurement trigger 201 and controls a counting operation and output of a performance counter 410.

Applications of the measurement trigger 201 are categorized into the following three types.

The first type is “measurement start trigger”, of which assertion starts the counting operation of the performance counter 410.

The second type is “measurement transfer trigger”, of which assertion causes copying a value of the performance counter 410 into a read buffer 420 and furthermore, processing, by the packetizing unit 430, each value of the performance counter into a packet, and providing the packet as performance counter packet output 431.

The third type is “measurement end trigger”, of which assertion ends the operation of the performance counter 410 and causes copying the value into the read buffer 420 and furthermore, processing, by the packetizing unit 430, each value of the performance counter into a packet, and providing the packet as the performance counter packet output 431.

The read buffer 420 stores measurement values received from at least one counter in the performance counter 410. Upon assertion of the measurement trigger 201, a controller 411 selects one or more counters from among the counters in the performance counter 410 to read counts thereof and copies the counts into the read buffer 420. Which counter in the performance counter 410 is to be selected is determined by the controller 411.

The packetizing unit 430 packetizes the data (counts) stored in the read buffer 420 and outputs them as performance packets. Which data (counts) in the read buffer 420 are to be packetized in what order and how many packets for each measurement trigger are to be generated are determined by a determination unit 421.

FIG. 1B shows an example of a structure of the performance counter 410 according to Embodiment 1 of the present invention. The performance counter 410 in this figure includes counters 410a to 410f and the controller 411.

The counter 410a is a counter which counts the number of machine cycles as one of the performance metrics.

The counter 410b is a counter which counts the number of instruction executions as one of the performance metrics.

The counter 410c is a counter which counts the number of cache misses as one of the performance metrics.

The counter 410d is a counter which counts the number of TLB misses as one of the performance metrics.

The counter 410e is a counter which counts the number of stall cycles as one of the performance metrics.

The counter 410f is a counter which counts the number of occurrences of conflicts as one of the performance metrics.

The controller 411 not only controls the above-mentioned copying of the counts into the read buffer 420, but also controls the counters 410a to 410f according to the measurement trigger. Specifically, upon assertion of “measurement start trigger”, the controller 411 starts the counting operation of the performance counter 410. Upon assertion of “measurement transfer trigger”, the controller 411 causes copying of the values of the performance counter 410 into the read buffer 420. Upon assertion of “measurement end trigger”, the controller 411 ends the operation of the performance counter 410 and causes copying of the values into the read buffer 420.

It is to be noted that the counters in the performance counter 410 are not limited to the above counters 410a to 410f. For example, there may be a counter which counts the number of occurrences of specific interrupts, a counter which counts the number of specific events, a counter which counts the number of occurrences of memory accesses to a specific address, and a counter which counts the number of occurrences of specific errors.

Furthermore, the controller 411 may determine the performance metrics to be measured, according to a user setting, select a counter corresponding to the determined performance metrics, and control the operation of only the selected counter. In other words, the controller 411 may operate only a counter indicated by a user and suspend a counter not indicated by a user among the counters in the performance counter 410.

FIG. 1C shows an example of a structure of a trace packet generated by the trace packet generation unit according to Embodiment 1 of the present invention.

The trace packet in this figure includes “Header”, “Type”, and “Address”. “Header” is information to identify the trace packet and may be, for example, a serial number. “Type” indicates, as a type of the address, whether the address is an address of a branch source or an address of a branch, specified by a branch instruction or an interrupt, or is an ID of a tag which indicates an execution address of a trace instruction or a debug instruction, or is other address. “Address” indicates an address of an instruction executed by the CPU.

FIG. 1D shows an example of a structure of the performance packet generated by the packetizing unit according to Embodiment 1 of the present invention. In this figure, six performance packets are shown which correspond to the counts of the counters 410a to 410f shown in FIG. 1B.

The performance packet in this figure includes “Event identification information (evID)”, “Class”, and “Count”. “Event identification information (evID)” is information to identify the measurement trigger and may be, for example, a serial number, characters, such as A, B and C, or symbols. “Class” indicates an object to be counted by each of the counters 410a to 410f, that is, the number of machine cycles, the number of instruction executions, the number of cache misses, the number of TLB misses, the number of stall cycles, or the number of occurrences of conflicts. “Count” is a count (that is, one of the performance metrics) of a corresponding counter. Since the performance packet shown in FIG. 1D includes the event identification information and the class of the count, the performance packet may be variable in length, and the number of performance packets for each measurement trigger may also be variable. In this case, the flexibility of output sequence of the performance packet can be increased.

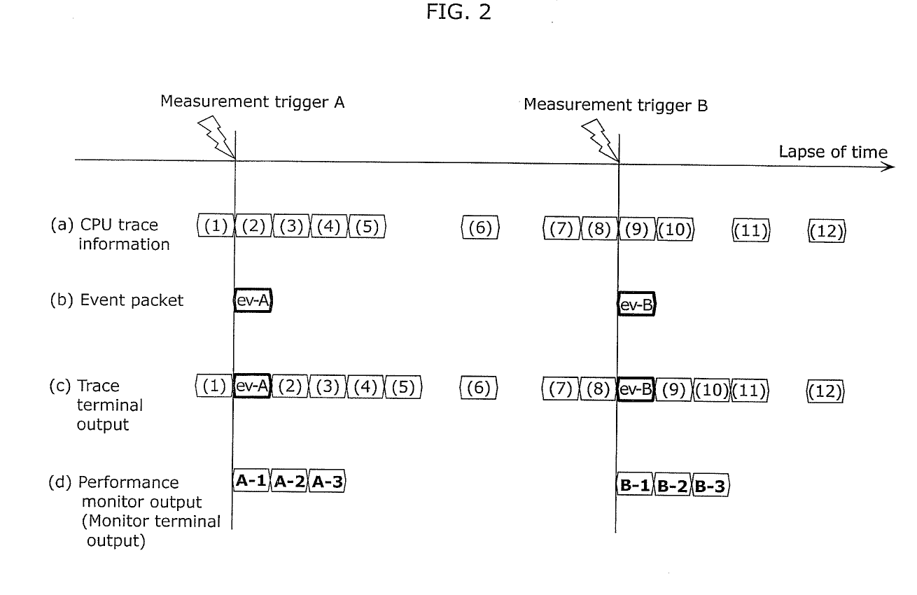

FIG. 2 is a timing chart showing the CPU trace and the data output of the performance monitor in the data processing apparatus based on the structure of FIG. 1A. FIG. 2 shows, in sequence from top, timing examples of (a) a trace packet that is CPU trace information (i.e., output of the trace packet generation unit 310), (b) an event packet (i.e., output of the event packet generation unit 330), (c) a trace packet and an event packet that are the trace terminal output 321 (i.e., output of the event packet insertion unit), and (d) the performance counter packet output 431 that is monitor terminal output (i.e., output of the performance monitor unit 400).

When a measurement trigger A is generated while the CPU trace information is generated in sequence (1), (2), (3), (4), and (5), the measurement trigger A causes the event packet generation unit 330 to generate an event packet “ev-A”. The event packet insertion unit 320 interrupts the packets of the CPU trace information following (2), (3), (4), and (5) to insert the event packet “ev-A” therein.

Meanwhile, the same measurement trigger A causes loading of snap shots of statistical performance data, namely performance monitor output “A-1”, “A-2”, and “A-3”, into the read buffer 420, and the packetizing unit 430 sequentially provides these snap shots in form of packets.

The event packet “ev-A” and the performance monitor output “A-1”, “A-2”, and “A-3” may additionally include header information so that they are associated with each other by the same identifier “A”. With this, a correlation can be easily established between the trace terminal output and the performance monitor output.

It is also shown that, likewise, when a measurement trigger B is generated while the CPU trace information is generated in sequence (7), (8), (9), and (10), the measurement trigger B causes insertion of an event packet “ev-B” into the trace terminal output, and at the same time, performance monitor output “B-1”, “B-2”, and “B-3” are provided in sequence.

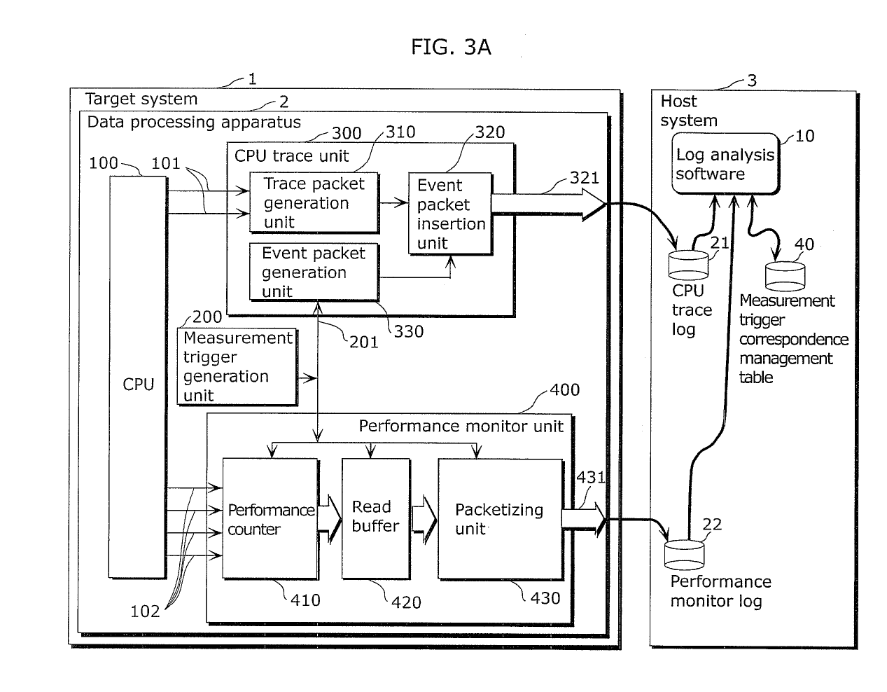

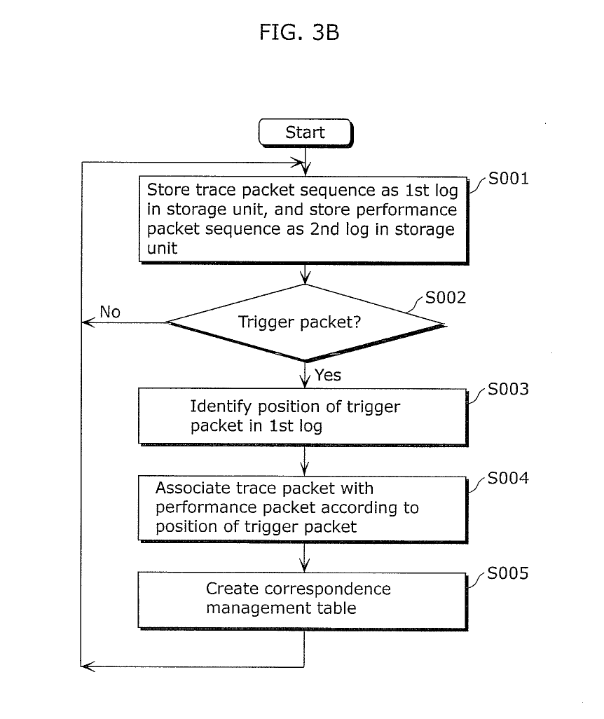

FIG. 3A shows an overall structure of a performance evaluation/analysis system including the above data processing apparatus. The trace terminal output 321 of a data processing apparatus 2 is connected to a host system 3 (a performance evaluation/analysis apparatus) via an LSI terminal and a connector of the data processing apparatus 2 so that a storage unit 21 obtains a CPU trace log. Likewise, the performance counter packet output 431 of the data processing apparatus 2 is connected to the host system via an LSI terminal and a connector of the data processing apparatus 2 so that a storage unit 22 obtains a performance monitor log. In the host system 3, the CPU trace log accumulated in the storage unit 21 and the performance monitor log accumulated in the storage unit 22 are analyzed with log analysis software 10 to create a measurement trigger correspondence management table 40, which makes it possible to associate the CPU trace with the statistical data of the performance monitor.

FIG. 3B is a flowchart showing an example of a performance evaluation/analysis method in the analysis apparatus. As shown in this figure, the host system 3 stores, as the CPU trace log (also referred to as the first log), a trace packet sequence received from the data processing apparatus 2, into the storage unit 21, and stores, as the performance monitor log (also referred to as the second log), a performance packet sequence received from the data processing apparatus 2, into the storage unit 22 (S001). The host system 3 determines whether the stored trace packet sequence includes an event packet (i.e., a trigger packet) (S002), and identifies the position, in the first log, of the event packet embedded in the first log (S003). Furthermore, the host system 3 associates a trace packet at a position following the identified position, with a performance packet corresponding to the trace packet (S004), and creates a correspondence management table as information indicating such a correspondence relationship (S005).

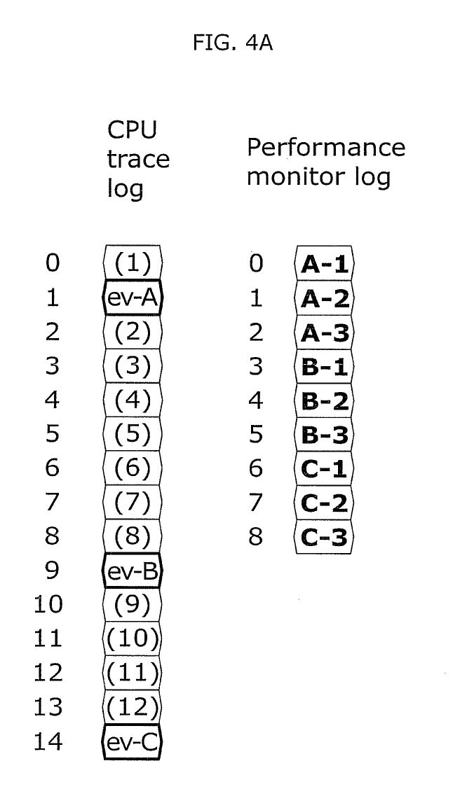

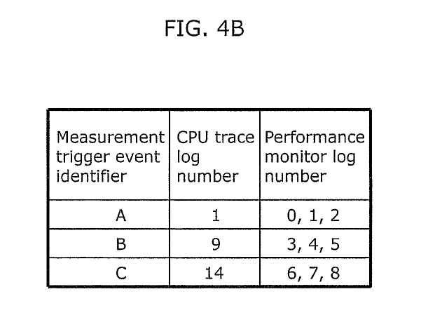

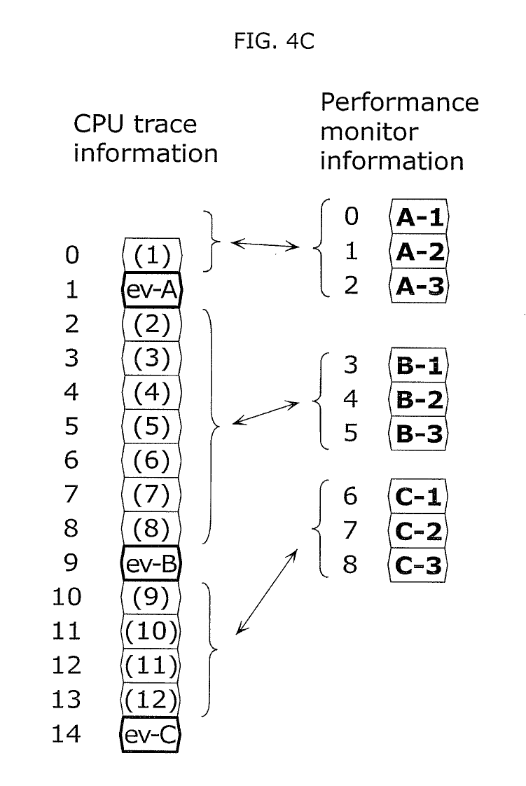

Operation of the log analysis software 10 is described with reference to FIGS. 4A, 4B, and 4C. The CPU trace log and the performance monitor log are provided with log numbers and stored in the storage units 21 and 22, respectively, as shown in FIG. 4A. With the log analysis software, the CPU trace log is scanned and when a measurement trigger event packet is found, then its log number is recorded in the measurement trigger correspondence management table. In the example of FIG. 4A, the event identifier “A” has a log number 1, and likewise, for the event identifies “B” and “C”, log numbers 9 and 14 are recorded, respectively. Next, the performance monitor log is scanned, and the log number of the statistical data, with the identifier “A”, of the performance monitor is recorded in the measurement trigger correspondence management table. In the example of FIG. 4A, the statistical data, with the identifier “A”, of the performance monitor have the log numbers 0, 1, and 2, and likewise, the statistical data, with the identifier “B”, of the performance monitor and the statistical data, with the identifier “C”, of the performance monitor have the log numbers 3, 4, and 5, and the log numbers 6, 7, and 8, respectively.

After completing the scanning of the CPU trace log and the performance monitor log, the log analysis software 10 outputs the CPU trace information and the performance monitor information in association with each other based on the measurement trigger correspondence management table 40. The associated logs are output in sequence according to the correspondence rule that the statistical data, with the identifier of a current measurement trigger event, of the performance monitor correspond to the CPU trace log from the last measurement trigger event to the current measurement trigger event. For example, the statistical information, with the identifier “A”, of the performance monitor is “A-1”, “A-2”, and “A-3”, and the CPU trace which corresponds to such information is data having a log number 0 or before in the CPU trace before an event packet “ev-A” of the measurement trigger. Likewise, “B-1”, “B-2” and “B-3” correspond to the CPU trace information with log numbers 2 to 8 between the event packets “ev-A” and “ev-B” of the measurement triggers, and “C-1”, “C-2” and “C-3” correspond to the CPU trace information with log numbers 10 to 13 between the event packets “ev-B” and “ev-C” of the measurement triggers.

As above, the CPU trace log and the performance monitor information can be output and displayed in association with each other.

It is to be noted that the determination unit 421 may determine, as the number of performance packets to be generated by the packetizing unit 430, a predetermined fixed number common to all the measurement triggers.

This eliminates the need of adding the identification information (“evID” in FIG. 1D) to each of the performance packets and thereby allows the packetizing unit 430 to omit such processing. This is because the performance evaluation/analysis apparatus is capable of readily associating the trace packets with the performance packets by counting, for each trigger packet, only the fixed number of performance packets corresponding to the trigger packet.

Furthermore, the determination unit may further determine the output order of the performance packets so that they are output in a predetermined fixed order common to all the measurement triggers.

This eliminates the need of adding the class (“Class” in FIG. 1D) to each of the performance packets and thereby allows the packetizing unit 430 to omit such processing. In this case, when each of the performance packets is fixed in length, the performance packet can be simplified to include only the count as shown in FIG. 1E. This allows the performance packet sequence to have a reduced length of transmission time and a reduced amount of data, which can save the memory area.

### Embodiment 2

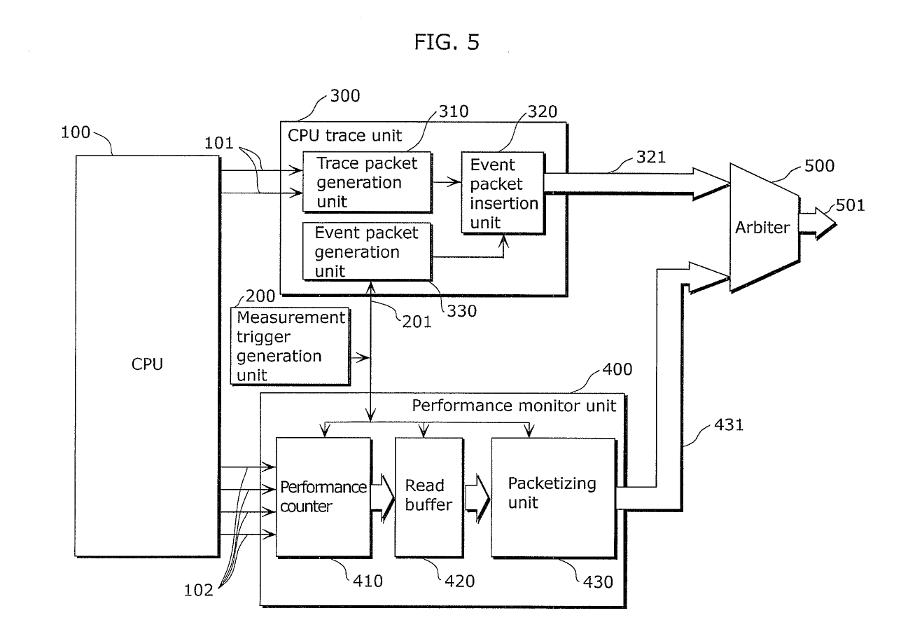

FIG. 5 shows a structure of a data processing apparatus according to Embodiment 2 of the present invention. This data processing apparatus includes the CPU 100 that executes software. From the CPU 100, the CPU-related trace information 101 is input to the CPU trace unit 300 and converted by the trace packet generation unit 310 into a CPU trace packet. In addition, from the CPU 100, the performance measurement event 102, such as the number of machine cycles, the number of instruction executions, the number of cache misses, the number of TLB misses, the number of stall cycles, or the number of occurrences of conflicts, collected to evaluate performance, is input to the performance monitor unit 400 and for every occurrence of each event, added to the performance counter.

The measurement trigger generation unit 200 generates the measurement trigger 201 for controlling a statistic operation of performance evaluation. A source of the measurement trigger may be an event occurring in a predetermined cycle because of overflow of a timer (not shown) or may be detection, by the CPU 100, of an execution of a function call/return instruction. It may also be that an instruction for debugging only is embedded in a program which the CPU 100 runs, and when the program is run, the measurement trigger generation unit 200 is notified thereof.

Upon assertion of the measurement trigger 201, the CPU trace unit 300 generates an event packet corresponding to the measurement trigger 201 in the event packet generation unit 330 and interrupts the CPU trace with the event packet in the event packet insertion unit 320, whereafter the trace terminal output 321 is input to an arbiter 500.

Meanwhile, the performance monitor unit 400 receives the same measurement trigger 201 and controls a counting operation and output of the performance counter 410.

Applications of the measurement trigger 201 are categorized into the following three types.

The first type is “measurement start trigger”, of which assertion starts the counting operation of the performance counter 410.

The second type is “measurement transfer trigger”, of which assertion causes copying a value of the performance counter 410 into the read buffer 420 and furthermore, processing, by the packetizing unit 430, each value of the performance counter into a packet, and inputting the packet as performance counter packet output 431 to the arbiter 500.

The third type is “measurement end trigger”, of which assertion ends the operation of the performance counter 410 and causes copying the value into the read buffer 420 and furthermore, processing, by the packetizing unit 430, each value of the performance counter into a packet, and inputting the packet as the performance counter packet output 431 to the arbiter 500.

The arbiter 500 that has received the trace terminal output 321 and the performance counter packet output 431 arbitrates the packets based on priority predetermined according to a user setting or based on a control of allocating a transfer band, and provides system trace output 510 to the trace terminal. Preferential outputting of the CPU trace which requires a wider trace band allows elimination of unnecessary use of buffer space.

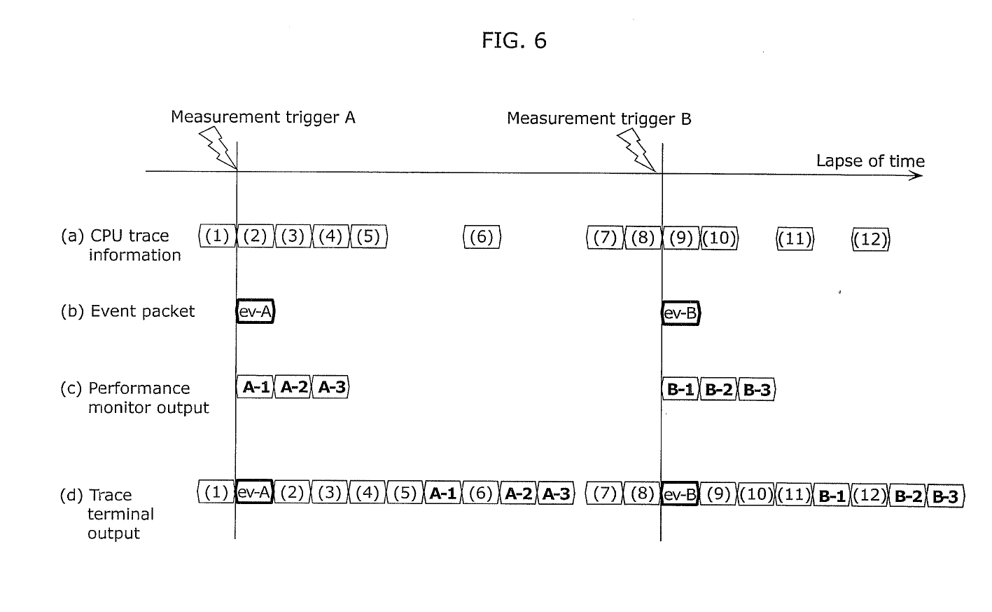

FIG. 6 is a timing chart showing the CPU trace and the data output of the performance monitor in the data processing apparatus based on the structure of FIG. 3A.

When the measurement trigger A is generated while the CPU trace information is generated in sequence (1), (2), (3), (4), and (5), the measurement trigger A causes the event packet generation unit 330 to generate the event packet “ev-A”. The event packet insertion unit 320 interrupts the packets of the CPU trace information following (2), (3), (4), and (5) to insert the event packet “ev-A” therein.

Meanwhile, the same measurement trigger A causes loading of snap shots of the statistical performance data, namely performance monitor output “A-1”, “A-2”, and “A-3”, into the read buffer 420, and the packetizing unit 430 sequentially provides these snap shots in form of packets to the arbiter 500. In this case, since high priority is given to the trace terminal output 321, “A-1” is provided when there is no trace terminal output 321, specifically, after packet (5). Likewise, “A-2” and “A-3” are provided after packet (6).

The event packet “ev-A” and the performance monitor output “A-1”, “A-2”, and “A-3” may additionally include header information so that they are associated with each other by the same identifier “A”. With this, an association can be easily made between a time point at which a measurement event occurs in the CPU trace and related performance monitor output even when the packets are output to a single trace terminal in a different order.

It is also shown that, likewise, when the measurement trigger B is generated while the CPU trace information is generated in sequence (7), (8), (9), and (10), the measurement trigger B causes insertion of the event packet “ev-B” into the trace terminal output, while the performance monitor output “B-1”, “B-2”, and “B-3” obtained at the same time as the insertion are provided in sequence in empty cycle of the CPU trace.

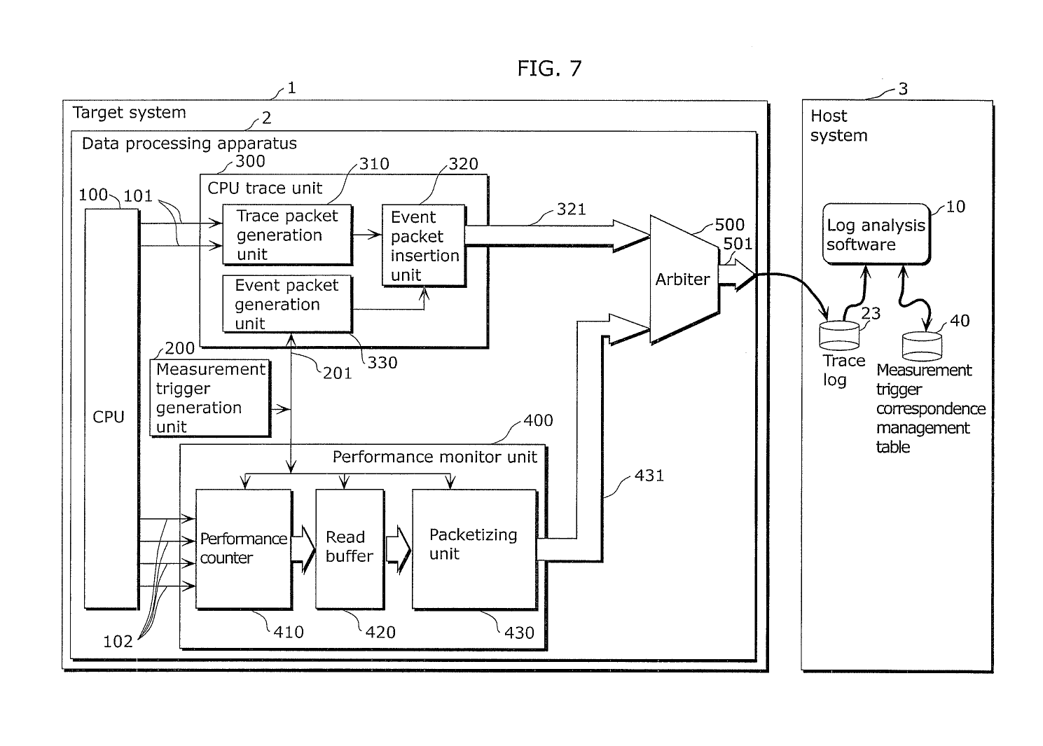

FIG. 7 shows an overall structure of a performance evaluation/analysis system including the above data processing apparatus. A system trace output 501 of the data processing apparatus 2 is connected to the host system 3 via an LSI terminal and a connector of the data processing apparatus 2 so that a storage unit 23 obtains a trace log. In the host system 3, the trace log accumulated in the storage unit 23 is analyzed with the log analysis software 10 to create the measurement trigger correspondence management table 40, which makes it possible to associate the CPU trace with the statistical data of the performance monitor.

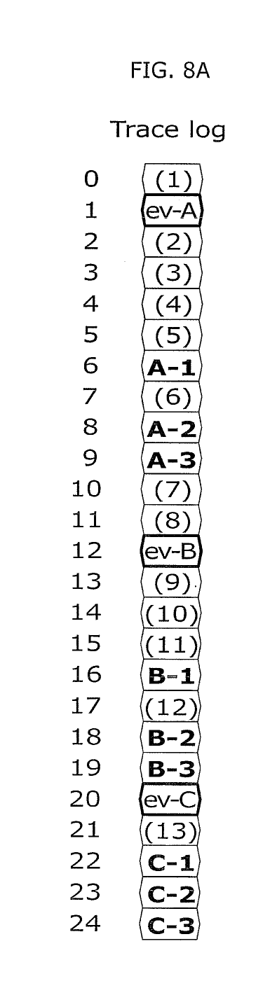

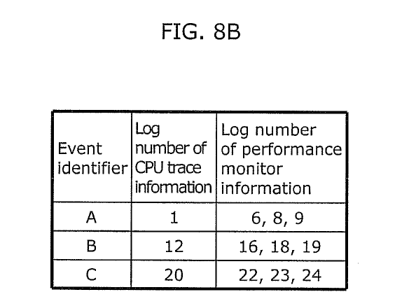

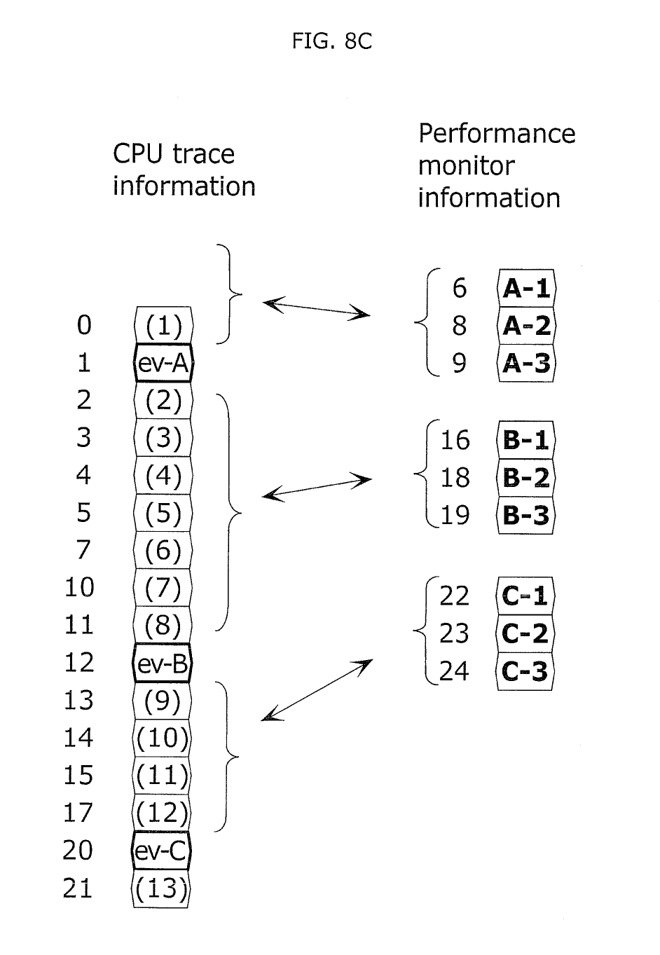

Operation of the log analysis software 10 is described with reference to FIGS. 8A, 8B, and 8C. The CPU trace and the statistical information of the performance monitor are combined into one stream as the trace log and stored in the storage unit 23 with the log numbers as shown in FIG. 8A. With the log analysis software, this trace log is scanned and when a measurement trigger event packet is found, then its log number is recorded in the measurement trigger correspondence management table. In the example of FIG. 8A, the event identifier “A” has a log number 1, and likewise, for the event identifies “B” and “C”, log numbers 12 and 20 are recorded, respectively. Next, the same log is scanned, and the log number of the statistical data, with the identifier “A”, of the performance monitor is recorded in the measurement trigger correspondence management table. In the example of FIG. 8A, the statistical data, with the identifier “A”, of the performance monitor have the log numbers 6, 8, and 9, and likewise, the statistical data, with the identifier “B”, of the performance monitor and the statistical data, with the identifier “C”, of the performance monitor have the log numbers 16, 18, and 19, and the log numbers 22, 23, and 24, respectively.

After completing the scanning of the trace log, the log analysis software 10 outputs the CPU trace information and the statistical information of the performance monitor in association with each other based on the measurement trigger correspondence management table 40. The associated logs are output in sequence according to the correspondence rule that the statistical data, with the identifier of a current measurement trigger event, of the performance monitor correspond to the CPU trace log from the last measurement trigger event to the current measurement trigger event. For example, the statistical information, with the identifier “A”, of the performance monitor is “A-1”, “A-2”, and “A-3”, and the CPU trace which corresponds to such information is data having a log number 0 or before in the trace log before the event packet “ev-A” of the measurement trigger. Likewise, “B-1”, “B-2” and “B-3” correspond to the CPU trace information with log numbers 2, 3, 4, 5, 7, 10, and 11 between the event packets “ev-A” and “ev-B” of the measurement triggers, and “C-1”, “C-2” and “C-3” correspond to the CPU trace information with log numbers 13, 14, 15, and 17 between the event packets “ev-B” and “ev-C” of the measurement triggers.

As above, the CPU trace information and the performance monitor information can be output and displayed in association with each other.

In the case where a new measurement trigger is generated while some performance packets yet to be output remain in the packetizing unit because of the high priority given to the trace packet by the arbiter 500, the performance monitor unit 400 may be configured to perform one of the following (i) and (ii) according to a user setting:

(i) discarding the remaining performance packets yet to be output and generating the performance packets which correspond to the new measurement trigger, that is, giving high priority to the performance packets corresponding to the new measurement trigger; and
(ii) holding generation of the performance packets which correspond to the new measurement trigger, without discarding the remaining performance packets yet to be output, that is, giving high priority to the remaining performance packets yet to be output.

Such a structure allows a user to select which is to be given high priority.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The data processing apparatus according to the present invention has a performance evaluation function which facilitates finding of a cause of performance degradation with a small increase in cost, and is useful for tuning performance of software running on the present data processing apparatus.

1. A data processing apparatus comprising:
a measurement trigger generation unit configured to generate a measurement trigger;
a performance monitor circuit that measures a performance measurement event collected from a central processing unit (CPU) and outputs a measurement value; and
a CPU trace circuit that generates, based on a signal indicating an operating state of the CPU, a trace packet sequence of trace information including an operation record of the CPU,
wherein upon receipt of the measurement trigger, said performance monitor circuit starts or ends measurement of performance metrics or outputs the measurement value,
the signal indicating an operating state of the CPU includes at least one of an address of an instruction executed by the CPU and identification information indicating a specific trace instruction executed by the CPU,
the performance metrics include at least one of the number of machine cycles, the number of instruction executions, the number of cache misses, the number of translation lookaside buffer (TLB) misses, the number of stall cycles, and the number of occurrences of conflicts, each of the numbers being counted within a period determined according to the measurement trigger, and
upon receipt of the measurement trigger, said CPU trace circuit generates a trigger packet and inserts the trigger packet into the trace packet sequence, the trigger packet indicating generation of the measurement trigger and being inserted at a position corresponding to timing with which the measurement trigger is generated.

2. The data processing apparatus according to claim 1,
wherein said performance monitor circuit includes at least one counter which measures the performance metrics,
the measurement trigger is a measurement start trigger, and
upon receipt of the measurement start trigger, said performance monitor circuit starts a counting operation of said at least one counter.

3. The data processing apparatus according to claim 1,
wherein said performance monitor circuit includes:
at least one counter which measures the performance metrics;
a read buffer into which the measurement value is copied from said at least one counter; and
a packetizing unit configured to packetize the measurement value copied into said read buffer and output the packetized measurement value as a performance packet,
the measurement trigger is a measurement transfer trigger, and
upon receipt of the measurement transfer trigger, said performance monitor circuit copies the measurement value from said at least one counter into said read buffer and starts a sequence operation of said packetizing unit, the sequence operation including the packetizing and the outputting of the performance packet.

4. The data processing apparatus according to claim 1,
wherein said performance monitor circuit includes:
at least one counter which measures the performance metrics;
a read buffer into which the measurement value is copied from said at least one counter; and
a packetizing unit configured to packetize the measurement value copied into said read buffer and output the packetized measurement value as a performance packet,
the measurement trigger is a measurement end trigger, and
upon receipt of the measurement end trigger, said performance monitor circuit copies the measurement value from said at least one counter into said read buffer, starts a sequence operation of said packetizing unit, and stops a counting operation, the sequence operation including the packetizing and the outputting of the performance packet.

5. The data processing apparatus according to claim 1, further comprising
an arbitration unit configured to arbitrate, according to a predetermined user setting, a conflict between a trace packet received from said CPU trace circuit and a performance packet received from said performance monitor circuit, and output the trace packet and the performance packet.

6. The data processing apparatus according to claim 1, further comprising
an arbitration unit configured to arbitrate a conflict between a trace packet received from said CPU trace circuit and a performance packet received from said performance monitor circuit so that high priority is given to the trace packet, and output the trace packet and the performance packet.

7. The data processing apparatus according to claim 6,
wherein said performance monitor circuit performs one of the following (i) and (ii) according to a user setting, when a new measurement trigger is generated while the performance packet yet to be output remains because of the high priority given to the trace packet by said arbitration unit:
(i) discarding the remaining performance packet and generating the performance packet which corresponds to the new measurement trigger; and
(ii) stopping generating the performance packet which corresponds to the new measurement trigger, without discarding the remaining performance packet.

8. The data processing apparatus according to claim 1,
wherein said performance monitor circuit includes:
at least one counter which measures the performance metrics;
a read buffer into which the measurement value is copied from said at least one counter; and
a packetizing unit configured to packetize the measurement value copied into said read buffer and output the packetized measurement value as a performance packet, and
the performance packet includes identification information on the measurement trigger, a class of a count, and the count.

9. The data processing apparatus according to claim 1,
wherein said performance monitor circuit includes:
at least one counter which measures the performance metrics;
a read buffer into which the measurement value is copied from said at least one counter; and
a packetizing unit configured to packetize the measurement value copied into said read buffer and output the packetized measurement value as a performance packet, and
said packetizing unit is configured to generate a predetermined fixed number of performance packets every time the measurement trigger is generated.

10. A performance evaluation/analysis apparatus which receives a trace packet sequence and a performance packet sequence from a data processing apparatus,
wherein a performance packet included in the performance packet sequence includes at least one of the number of machine cycles, the number of instruction executions, the number of cache misses, the number of translation lookaside buffer (TLB) misses, the number of stall cycles, and the number of occurrences of conflicts, each of the numbers being counted within a period determined according to a measurement trigger,
a trace packet included in the trace packet sequence includes: at least one of an address of a instruction executed by a central processing unit (CPU) and identification information indicating a specific trace instruction executed by the CPU; and a trigger packet indicating generation of the measurement trigger, and
said performance evaluation/analysis apparatus comprises:
a first storage unit configured to store, as a first log, the trace packet sequence received from the data processing apparatus;
a second storage unit configured to store, as a second log, the performance packet sequence received from the data processing apparatus; and
an analysis unit configured to (i) identify a position, in the first log, of a trigger packet embedded in the first log, (ii) associate the trace packet and the performance packet according to the position, and (iii) output information indicating a correspondence relationship between the trace packet and the performance packet.

11. A performance evaluation/analysis system comprising:
a data processing apparatus comprising:
a measurement trigger generation unit configured to generate a measurement trigger;
a performance monitor circuit that measures a performance measurement event collected from a central processing unit (CPU) and outputs a measurement value; and
a CPU trace circuit that generates, based on a signal indicating an operating state of the CPU, a trace packet sequence of trace information including an operation record of the CPU,
wherein upon receipt of the measurement trigger, said performance monitor circuit starts or ends measurement of performance metrics or outputs the measurement value,
the signal indicating an operating state of the CPU includes at least one of an address of an instruction executed by the CPU and identification information indicating a specific trace instruction executed by the CPU,
the performance metrics include at least one of the number of machine cycles, the number of instruction executions, the number of cache misses, the number of translation lookaside buffer (TLB) misses, the number of stall cycles, and the number of occurrences of conflicts, each of the numbers being counted within a period determined according to the measurement trigger, and
upon receipt of the measurement trigger, said CPU trace circuit generates a trigger packet and inserts the trigger packet into the trace packet sequence, the trigger packet indicating generation of the measurement trigger and being inserted at a position corresponding to timing with which the measurement trigger is generated; and
said performance evaluation/analysis apparatus according to claim 10.

12. A performance evaluation/analysis method in a performance evaluation/analysis apparatus which receives a trace packet sequence and a performance packet sequence from a data processing apparatus,
wherein a performance packet included in the performance packet sequence includes at least one of the number of machine cycles, the number of instruction executions, the number of cache misses, the number of translation lookaside buffer (TLB) misses, the number of stall cycles, and the number of occurrences of conflicts, each of the numbers being counted within a period determined according to a measurement trigger,
a trace packet included in the trace packet sequence includes: at least one of an address of a instruction executed by a central processing unit (CPU) and identification information indicating a specific trace instruction executed by the CPU; and a trigger packet indicating generation of the measurement trigger, and
said performance evaluation/analysis method comprises:
storing, as a first log, the trace packet sequence received from the data processing apparatus;
storing, as a second log, the performance packet sequence received from the data processing apparatus;
identifying a position, in the first log, of a trigger packet embedded in the first log;
associating the trace packet and the performance packet according to the position; and
outputting information indicating a correspondence relationship between the trace packet and the performance packet.

13. A semiconductor device comprising:
a measurement trigger generation unit configured to generate a measurement trigger;
a performance monitor circuit that measures a performance measurement event collected from a central processing unit (CPU) and outputs a measurement value; and
a CPU trace circuit that generates, based on a signal indicating an operating state of the CPU, a trace packet sequence of trace information including an operation record of the CPU,
wherein upon receipt of the measurement trigger, said performance monitor circuit starts or ends measurement of performance metrics or outputs the measurement value,
the signal indicating an operating state of the CPU includes at least one of an address of an instruction executed by the CPU and identification information indicating a specific trace instruction executed by the CPU,
the performance metrics include at least one of the number of machine cycles, the number of instruction executions, the number of cache misses, the number of translation lookaside buffer (TLB) misses, the number of stall cycles, and the number of occurrences of conflicts, each of the numbers being counted within a period determined according to the measurement trigger, and upon receipt of the measurement trigger, said CPU trace circuit generates a trigger packet and inserts the trigger packet into the trace packet sequence, the trigger packet indicating generation of the measurement trigger and being inserted at a position corresponding to timing with which the measurement trigger is generated.
